(19) United States
(12) Patent Application Publication
(10) Pub. No.: US 2023/0042477 A1
(43) Pub. Date: Feb. 9, 2023

(54) REPRODUCTION CONTROL METHOD, CONTROL SYSTEM, AND PROGRAM

(71) Applicant: Yamaha Corporation, Hamamatsu (JP)

(72) Inventor: Tatsuya IRIYAMA, Hamamatsu (JP)

(21) Appl. No.: 17/966,771

(22) Filed: Oct. 14, 2022

Related U.S. Application Data
(63) Continuation of application No. PCT/JP2021/011032, filed on Mar. 18, 2021.

(30) Foreign Application Priority Data
Apr. 17, 2020 (JP) 2020-074260

(51) Int. Cl. G10L 13/033

(52) U.S. Cl. CPC G10L 13/033

(57) ABSTRACT

A reproduction control method implemented by a computer includes receiving, from a first terminal device, a first reproduction request in accordance with an instruction from a first user, receiving, from a second terminal device, a second reproduction request in accordance with an instruction from a second user, acquiring a first acoustic signal representing a first sound in accordance with the first reproduction request, and a second acoustic signal representing a second sound which is in accordance with the second reproduction request and have acoustic characteristics that differ from acoustic characteristics of the first sound represented by the first acoustic signal, mixing the first acoustic signal and the second acoustic signal, thereby generating a third acoustic signal, and causing a reproduction system to reproduce a third sound represented by the third acoustic signal.

### CROSS-REFERENCE TO RELATED APPLICATIONS

This application is a continuation application of International Application No. PCT/JP2021/011032, filed on Mar. 18, 2021, which claims priority to Japanese Patent Application No. 2020-074260 filed in Japan on Apr. 17, 2020. The entire disclosures of International Application No. PCT/JP2021/011032 and Japanese Patent Application No. 2020-074260 are hereby incorporated herein by reference.

### BACKGROUND

### Technological Field

The present disclosure relates to technology for controlling reproduction of sound in an acoustic space, such as an auditorium.

### Background Information

For example, a system for the remote viewing by a large number of users of an event such as a concert or a live performance taking place in an acoustic space such as an auditorium has been proposed in the prior art (for example, U.S. Pat. No. 9,131,016).

### SUMMARY

However, in a situation in which remote users view an even in an acoustic space, there is the problem that it is difficult for a performer such as a singer or a musician that is present in the acoustic space to ascertain the situation of users who are viewing the performance. For example, the performer may not be able to ascertain the total number of remote users or their reactions.

A reproduction control method according to one aspect of the present disclosure is implemented by a computer and comprises receiving, from a first terminal device, a first reproduction request in accordance with an instruction from a first user, receiving, from a second terminal device, a second reproduction request in accordance with an instruction from a second user, acquiring a first acoustic signal representing a first sound in accordance with the first reproduction request, and a second acoustic signal representing a second sound which is in accordance with the second reproduction request and have acoustic characteristics that differ from acoustic characteristics of the first sound represented by the first acoustic signal, mixing the first acoustic signal and the second acoustic signal, thereby generating a third acoustic signal, and causing a reproduction system to reproduce a third sound represented by the third acoustic signal.

A control system according to one aspect of the present disclosure comprises an electronic controller including at least one processor. The electronic controller is configured to execute a plurality of modules including a receiving module configured to receive, from a first terminal device, a first reproduction request in accordance with an instruction by a first user, and receive, from a second terminal device, a second reproduction request in accordance with an instruction by a second user; an acquisition module configured to acquire a first acoustic signal representing a first sound in accordance with the first reproduction request, and a second acoustic signal representing a second sound that is in accordance with the second reproduction request and has acoustic characteristics that differ from acoustic characteristics of the first sound represented by the first acoustic signal, a mixing module configured to mix the first acoustic signal and the second acoustic signal, thereby generating a third acoustic signal, and a reproduction module configured to cause a reproduction system to reproduce a third sound represented by the third acoustic signal.

A non-transitory computer-readable medium storing a program according to one aspect of the present disclosure causes a computer to function as a receiving module configured to receive, from a first terminal device, a first reproduction request in accordance with an instruction by a first user, and receive, from a second terminal device, a second reproduction request in accordance with an instruction by a second user, an acquisition module configured to acquire a first acoustic signal representing a first sound in accordance with the first reproduction request, and a second acoustic signal representing a second sound that is in accordance with the second reproduction request and has acoustic characteristics that differ from acoustic characteristics of the first sound represented by the first acoustic signal, a mixing module configured to mix the first acoustic signal and the second acoustic signal to generate a third acoustic signal, and a reproduction module configured to cause a reproduction system to reproduce a third sound represented by the third acoustic signal.

### BRIEF DESCRIPTION OF THE DRAWINGS

FIG. 1 is a block diagram illustrating the configuration of a communication system according to a first embodiment.

FIG. 2 is a block diagram illustrating the configuration of a terminal device.

FIG. 3 is a flowchart illustrating the specific procedure of an acceptance process.

FIG. 4 is a block diagram illustrating the configuration of a control system.

FIG. 5 is a flowchart illustrating the specific procedure of a reproduction control process.

FIG. 6 is a block diagram illustrating the configuration of a control device in a fourth embodiment.

FIG. 7 is a flowchart illustrating the specific procedure of a reproduction control process in the fourth embodiment.

FIG. 8 is an explanatory diagram of a setting process and an adjustment process in the reproduction control process of the fourth embodiment.

FIG. 9 is an explanatory diagram of the setting process in a fifth embodiment.

### DETAILED DESCRIPTION OF THE EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

### A: First Embodiment

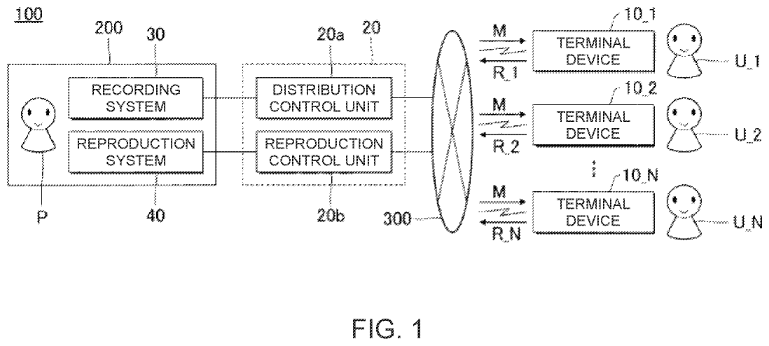

FIG. 1 is a block diagram illustrating the configuration of a communication system 100 according to the first embodiment. The communication system 100 has a plurality of N terminal devices 10_1 to 10_N (N is a positive integer of 2 or more), a control system (computer system) 20, a recording system 30, and a reproduction system 40. In the following description, the index n is added to the reference symbol of the element relating to any one terminal device 10_n (n=1 to N) from among N terminal devices 10_1 to 10_N. The number N of the terminal devices 10_n is a variable numerical value.

The recording system 30 and the reproduction system 40 is installed in a facility 200 where various events are held. The facility 200 is an acoustic space where music events are held. A performer P performs in the music event. For example, various types of music events can be assumed, such as live concerts in which the performer P sings a musical piece or the performer P plays a musical instrument. For example, an auditorium, a music venue, an outdoor stage, etc., are specific examples of the facility 200. In the first embodiment, it is assumed that an audience is not present in the facility 200. For example, for various reasons, such as preventing the spread of infectious diseases, music events can be held without an audience in the facility 200. In a normal music event, the performer P can ascertain the situation of the audience in the facility 200, but in the music event of the first embodiment, the performer P cannot ascertain the situation of the audience in the facility 200.

The recording system 30 records video of a music event held in the facility 200. Specifically, the recording system 30 comprises an image capture device that captures images of the music event, and a sound collection device that collects the sounds of the music event. The recording system 30 generates a video consisting of the images captured by the image capture device and the sounds collected by the sound collection device.

The reproduction system 40 reproduces the sounds within the facility 200. The reproduction system 40 is provided with a plurality of sound output devices (for example, speaker devices) installed in different locations within the facility 200, for example. The performer P of the music event can listen to the sound reproduced by the reproduction system 40 during the performance at the music event. The recording system 30 and the reproduction system 40 can communicate with the control system 20.

The control system 20 comprises a distribution control unit 20a and a reproduction control unit 20b. The distribution control unit 20a distributes video data M representing the video recorded by the recording system 30 to each of the N terminal devices 10_1 to 10_N. The video data M are streamed to each terminal device 10_n in a real-time manner (in real time), in parallel with the course of the music event, for example. The reproduction control unit 20b causes the reproduction system 40 to reproduce sound in response to an instruction from each user U_n of the N terminal devices 10_1 to 10_N. A system equipped with the distribution control unit 20a and a system equipped with the reproduction control unit 20b can be installed separately.

Each of the N terminal devices 10_1 to 10_N is a portable information terminal, such as a smartphone or a tablet device. A stationary or portable personal computer can be used as a terminal device 10_n. Each terminal device 10_n communicates with the control system 20 via a communication network 300, such as a mobile communication network or the Internet. The user U_n of the terminal device 10_n is located outside the facility 200. For example, the user U_n is at a location (for example, at home) remote from the facility 200.

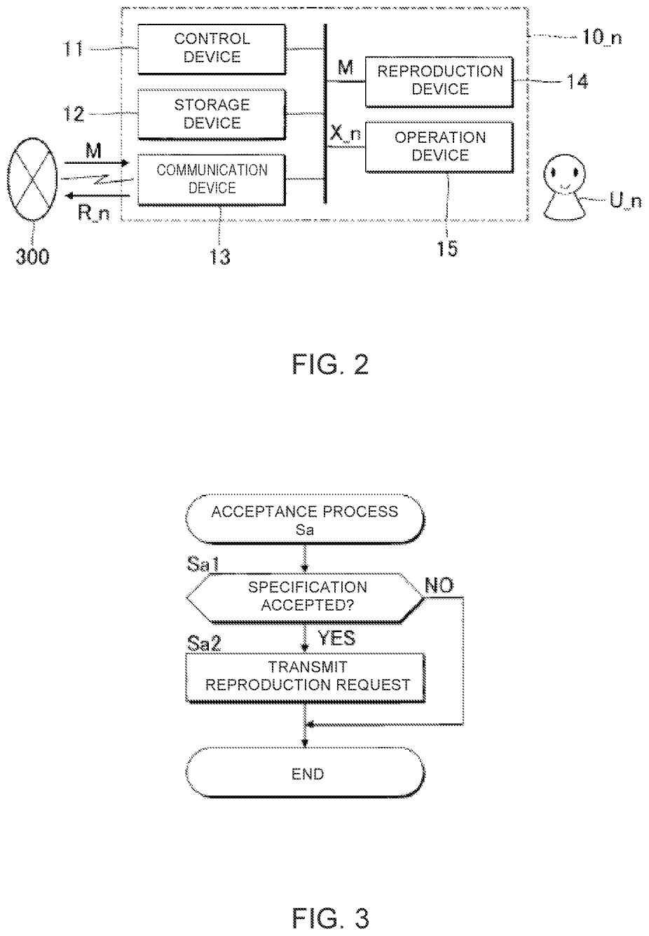

FIG. 2 is a block diagram illustrating a configuration of the terminal device 10_n. The terminal device 10_n is equipped with a control device 11, a storage device 12, a communication device 13, a reproduction device 14, and an operation device 15. The terminal device 10_n can be realized as a single device or as a group of separately configured devices.

The control device 11 is, for example, an electronic controller including one or more processors that control each element of the terminal device 10_n. For example, the control device 11 can be one or a plurality of types of processors, such as a CPU (Central Processing Unit), an SPU (Sound Processing Unit), a DSP (Digital Signal Processor), an FPGA (Field Programmable Gate Array), an ASIC (Application Specific Integrated Circuit), etc. Here, the term “electronic controller” as used herein refers to hardware, and does not include a human.

The storage device 12 comprises one or a plurality of computer memories or memory units for storing a program that is executed by the control device 11 and various data that are used by the control device 11. The storage device 12 is formed by a known storage medium, such as a magnetic storage medium or a semiconductor storage medium. The storage device 12 can be formed by a combination of a plurality of types of storage media. Thus, the storage device 12 can be any computer storage device or any computer readable medium with the sole exception of a transitory, propagating signal. For example, the storage device 12 can be a computer memory which can be nonvolatile memory and volatile memory.

The communication device 13 is a hardware device capable of transmitting an analog or digital signal over the telephone, other communication wire, or wirelessly. In this disclosure, the communication device 13 communicates with the control system 20 via the communication network 300. For example, the communication device 13 receives video data M transmitted from the control system 20. The reproduction device 14 reproduces video including images and sounds under the control of the control device 11. Specifically, the reproduction device 14 comprises a display device (display) that displays images and a sound output device that emits sound.

The control device 11 causes the reproduction device 14 to reproduce video represented by the video data M received by the communication device 13. That is, a video of the music event is played by the reproduction device 14 of each terminal device 10_n, in parallel with the progress of the music event. As can be understood from the foregoing explanation, a plurality of (N) users U_1 to U_N using different terminal devices 10_n watch the video of the music event outside of the facility 200.

The operation device 15 is an input device that accepts instructions from the user U_n. The operation device 15 is, for example, a plurality of operators operated by the user U_n, or a touch panel that detects haptic contact from the user U_n.

The user U_n operates the operation device 15 to input a desired character string X_n. Specifically, the user U_n can specify the character string X_n at any point in time while watching the video of the music event played by the reproduction device 14. The character string X_n is formed by one or more words representing, for example, cheers for the performer P of the music event. For example, various types of character strings X_n, such as the name of the performer P and exclamations such as “Oh” and “Wow” are specified by the user U_n. That is, the character string X_n represents cheers that the audience vocalizes to the performer P in a normal music event in which the audience is located in the facility 200.

FIG. 3 is a flowchart illustrating the specific procedure of a process (hereinafter referred to as “acceptance process”) Sa that the control device 11 of the terminal device 10_n executes in relation to the character string X_n. The acceptance process Sa is repeated at a prescribed cycle during the period which the video represented by the video data M is played.

When the acceptance process Sa is started, the control device 11 determines whether the character string X_n has been accepted from the user U_n (process Sa1). If the character string X_n has been accepted (process Sa1: YES), the control device 11 transmits a reproduction request R_n including the character string X_n from the communication device 13 to the control system 20 (process Sa2). The reproduction request R_n is data requesting that the sound corresponding to the character string X_n be reproduced inside the facility 200. On the other hand, if the character string X_n is not accepted (process Sa1: NO), the reproduction request R_n is not transmitted (process Sa2). As can be understood from the foregoing explanation, the reproduction request R_n in accordance with the instruction from the user U_n is transmitted from each of the N terminal devices 10_1 to 10_N to the control system 20 in parallel or sequentially.

For the sake of convenience, two arbitrary users U_n1 and U_n2 from among the N users U_1 to U_n (n1≠n2) are the focus of the following description. For example, the acceptance process Sa causes a reproduction request R_n1 including a character string X_n1 specified by the user U_n1 to be transmitted from the terminal device 10_n1, and a reproduction request R_n2 including a character string X_n2 specified by a user U_n2 to be transmitted from a terminal device 10_n2.

The terminal device 10_n1 is one example of the “first terminal device.” The terminal device 10_n2 is one example of the “second terminal device.” Further, the user U_n1 is one example of the “first user.” The user U_n2 is one example of the “second user.” The reproduction request R_n1 is one example of the “first reproduction request” and the reproduction request R_n2 is one example of the “second reproduction request.” The character string X_n1 is one example of a “first character string.” The character string X_n2 is one example of a “second character string.”

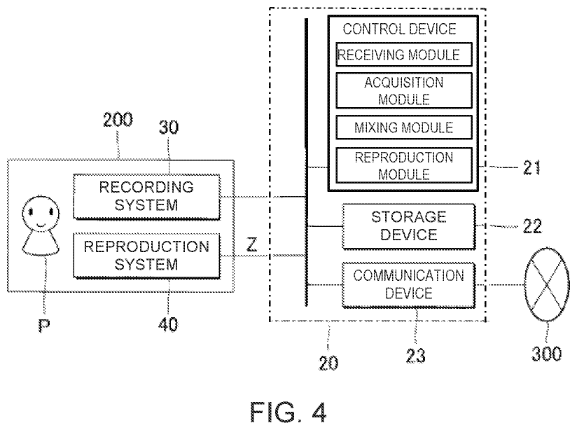

FIG. 4 is a block diagram illustrating the configuration of the control system 20. The control system 20 comprises a control device 21, a storage device 22, and a communication device 23. The control system 20 can be realized as a single device or as a group of separately configured devices.

The control device 21 is, for example, an electronic controller including one or a plurality of processors that control each element of the control system 20. For example, the control device 21 includes one or more types of processors, such as a CPU, an SPU, a DSP, an FPGA, an ASIC, etc. Here, the term “electronic controller” as used herein refers to hardware, and does not include a human. The control device 21 realizes a plurality of functions (a receiving module, an acquisition module, a mixing module, and a reproduction module).

The storage device 22 includes one or a plurality of computer memories or memory units for storing a program that is executed by the control device 21 and various data that are used by the control device 21. The storage device 22 is formed by a known storage medium, such as a magnetic storage medium or a semiconductor storage medium. The storage device 22 can be formed by a combination of a plurality of types of storage media, and can be any computer storage device or any computer readable medium with the sole exception of a transitory, propagating signal. For example, the storage device 22 can be a computer memory which can be nonvolatile memory and volatile memory. The program, which is stored in a non-transitory computer-readable medium, such as the storage device 22, causes the control device 21 to execute a reproduction control method or function as the receiving module, the acquisition module, the mixing module, and the reproduction module.

The communication device 23 is a hardware device capable of transmitting an analog or digital signal over the telephone, other communication wire, or wirelessly. In this disclosure, the communication device 23 communicates with each of the N terminal devices 10_1 to 10_N via the communication network 300. For example, the communication device 23 transmits video data M representing video recorded by the recording system 30 to each terminal device 10_n. Further, the communication device 23 receives the reproduction request R_n transmitted from each of the N terminal devices 10_1 to 10_N. The communication device 23 can communicate with the recording system 30 or the reproduction system 40 via the communication network 300.

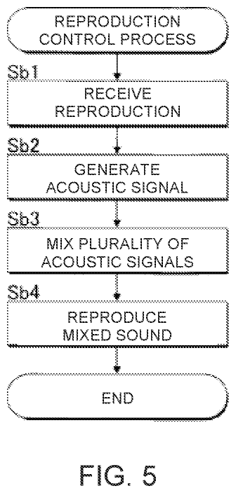

FIG. 5 is a flowchart illustrating the specific procedure of a process (hereinafter referred to as “reproduction control process”) Sb executed by the control device 21 (reproduction control unit 20b). For example, the reproduction control process Sb is repeated at a prescribed cycle.

When the reproduction control process Sb is started, the control device 21 receives from the communication device 23 the reproduction request R_n transmitted from each terminal device 10_n (process Sb1). That is, the control device 21 receives the reproduction request R_n from one or more of the terminal devices 10_n out of the N terminal devices 10_1 to 10_N. For example, the control device 21 receives the reproduction request R_n1 from the terminal device 10_n1, and the reproduction request R_n2 from the terminal device 10_n2. As described above, the control device 21 functions as an element (receiving module (receiving unit)) that receives the reproduction request R_n from each of the plurality of terminal devices 10_n.

The control device 21 generates an acoustic signal Y_n in accordance with the reproduction request R_n for each reproduction request R_n received from the terminal device 10_n (process Sb2). For example, an acoustic signal Y_n1 in accordance with the reproduction request R_n1 and an acoustic signal Y_n2 in accordance with the reproduction request R_n2 are generated. The acoustic signal Y_n is a signal representing the waveform of the sound corresponding to the character string X_n included in the reproduction request R_n. That is, the acoustic signal Y_n representing the sound generated when a virtual speaker reads the character string X_n. Specifically, the acoustic signal Y_n representing cheers for the performer P of the music event is generated. The time length of the acoustic signal Y_n is variable and depends on the number of characters that make up the character string X_n. For example, the greater the number of characters in the character string X_n, the longer the time length of the acoustic signal Y_n.

The control device 21 generates each acoustic signal Y_n such that the pitch differs for each acoustic signal Y_n. For example, the pitch (one example of acoustic characteristics pf the first sound) of the acoustic signal Y_n1 differs from the pitch (one example of acoustic characteristics of the second sound) of the acoustic signal Y_n2. The acoustic signal Y_n1 is one example of the “first acoustic signal.” The acoustic signal Y_n2 is one example of the “second acoustic signal.”

The control device 21 of the first embodiment generates the acoustic signal Y_n by a speech synthesis process to which the character string X_n is applied. For example, the control device 21 generates the acoustic signal Y_n1 by applying the character string X_n1 to the speech synthesis process and generates the acoustic signal Y_n2 by applying the character string X_n2 to the speech synthesis process. Any known speech synthesis technology can be employed to generate the acoustic signal Y_n. For example, a concatenative speech synthesis process, which connects a plurality of speech elements, can be used to generate the acoustic signal Y_n. In addition, a statistical model-type speech synthesis process, which uses a statistical model such as a deep neural network or an HMM (Hidden Markov Model), can be used to generate the acoustic signal Y_n. The parameters applied to the speech synthesis process can be adjusted in order to vary the pitch of each acoustic signal Y_n. As can be understood from the foregoing explanation, the control device 21 functions as an element (acquisition module (acquisition unit)) that acquires the acoustic signal Y_n in accordance with the reproduction request R_n.

The control device 21 mixes a plurality of the acoustic signals Y_n, thereby generating an acoustic signal Z (process Sb3). The position of each acoustic signal Y_n on the time axis is set in accordance with the time at which the control device 21 receives the reproduction request R_n. For example, if the reproduction request R_n1 is received before the reproduction request R_n2 is received, the acoustic signal Y_n1 and the acoustic signal Y_n2 are mixed such that the starting point of the acoustic signal Y_n1 is before the starting point of the acoustic signal Y_n2. As can be understood from the foregoing explanation, the control device 21 functions as an element (mixing module (mixing unit)) that mixes a plurality of the acoustic signals Y_n.

Although it is possible to mix the plurality of acoustic signals Y_n all at once, the plurality of the acoustic signals Y_n can be mixed in a stepwise manner. For example, the control device 21 divides the plurality of the acoustic signals Y_n into a plurality of groups and mixes two or more acoustic signals Y_n for each group to generate an intermediate signal (first step). The control device 21 then further mixes a plurality of intermediate signals corresponding to the different groups to generate the acoustic signal Z (second step). Further, various acoustic effects such as reverberation can be applied to each acoustic signal Y_n, after which the plurality of the acoustic signals Y_n can be mixed. In a configuration in which the plurality of the acoustic signals Y_n are mixed in a stepwise manner, the acoustic effects can be added at each step.

The control device 21 causes the reproduction system 40 to reproduce the sound represented by the acoustic signal Z (process Sb4). Specifically, the control device 21 supplies the acoustic signal Z to the reproduction system 40, so that the sound represented by the acoustic signal Z is reproduced. That is, the control device 21 functions as an element (reproduction module (reproduction unit)) that causes the reproduction system 40 to reproduce the sound (third sound) represented by the acoustic signal Z after mixing.

As can be understood from the foregoing explanation, a mixed sound of cheers specified by the plurality of users U_n is reproduced in the facility 200. In the first embodiment, since the acoustic characteristics of the sounds represented by each acoustic signal Y_n are different, compared to a configuration in which the acoustic characteristic of the plurality of the acoustic signals Y_n are the same, there is the advantage that the performer P of the music event can more readily ascertain the situation of the users U_n. For example, the performer P can ascertain the reactions or the total number (scale) of the users U_n.

In the first embodiment, the acoustic signal Y_n representing the sound corresponding to the character string X_n specified by each user U_n is generated by speech synthesis process applied to said character string X_n. Therefore, there is the advantage that various acoustic signals Y_n corresponding to any character string X_n specified by each user U_n can be generated.

### B: Second Embodiment

The second embodiment will be described. In each of the embodiments illustrated below, elements that have the same functions as in the first embodiment have been assigned the same reference symbols as those used to describe the first embodiment, and their detailed descriptions have been appropriately omitted.

The storage device 12 of each terminal device 10_n stores attribute information representing the attributes of the user U_n. The attributes of the user U_n are, for example, the age or sex of the user U_n. The reproduction request R_n of the second embodiment includes the same character string X_n as the first embodiment, and the attribute information stored in the storage device 12. Specifically, when the character string X_n is accepted from the user U_n in the acceptance process Sa (process Sa1: YES), the control device 21 transmits the reproduction request R_n including the character string X_n and the attribute information of the user U_n from the communication device 13 to the control system 20 (process Sa2).

In the speech synthesis process of the reproduction control process Sb, the control device 21 of the control system 20 generates the acoustic signal Y_n representing voice quality in accordance with the attribute information in each reproduction request R_n (process Sb2). Specifically, the control device 21 can generate the acoustic signal Y_n that represents voice with greater intelligibility (that is, voices of young people) for younger ages as are represented by the attribute information. Voice with greater intelligibility is, for example, voice in which the harmonic components are more pronounced than the non-harmonic components (breath components). Further, the control device 21 generates the acoustic signal Y_n representing the voice quality of a male voice or a female voice in accordance with the sex represented by the attribute information. As can be understood from the foregoing explanation, the control device 21 of the second embodiment generates the acoustic signal Y_n1 representing the voice quality in accordance with the attributes of the user U_n1 and the acoustic signal Y_n2 representing the voice quality in accordance with the attributes of the user U_n2. The process for mixing the plurality of the acoustic signals Y_n and the process for reproducing the acoustic signal Z are the same as those of the first embodiment.

The same effects as those of the first embodiment are realized in the second embodiment. Further, in the second embodiment, it is possible to generate the acoustic signal Y_n representing various voice qualities in accordance with the attributes of each of the users U_n. Moreover, there is the advantage that the performer that hears the sound reproduced by the reproduction system 40 can ascertain the general attributes of the plurality of users U_n who are listening to the music event. The voice quality of the sound represented by the acoustic signal Y_n is not necessarily the voice quality that matches the attribute of the user U_n. For example, the acoustic signal Y_n representing a female voice can be generated when the sex represented by the attribute information of the user U_n is male. That is, any configuration can be employed as long as the voice quality (one example of an acoustic characteristic) represented by the acoustic signal Y_n is configured to change in accordance with the attribute of the user U_n.

### C: Third Embodiment

The control device 21 of the control system 20 in the third embodiment generates the acoustic signal Y_n representing voice with a volume in accordance with the character string X_n in the speech synthesis process of the reproduction control process Sb (process Sb2). Specifically, the control device 21 generates the acoustic signal Y_n with a higher volume as the number of characters of the character string X_n increases. As can be understood from the foregoing explanation, the control device 21 of the third embodiment generates the acoustic signal (acoustic signal representing voice with a volume proportional to the length of the character string X_n1) Y_n1 representing voice with a volume in accordance with the character string X_n1, and generates the acoustic signal Y_n2 representing volume in accordance with the character string X_n2.

The same effects as those of the first embodiment are realized in the third embodiment. Further, in the third embodiment, it is possible to generate the acoustic signal Y_n representing voice of various volumes in accordance with the character string X_n specified by each user U_n. The configuration of the second embodiment for controlling voice quality represented by the acoustic signal Y_n in accordance with the attribute of the user U_n, and the configuration of the third embodiment for controlling the volume of voice represented by the acoustic signal Y_n in accordance with the character string X_n can be combined.

Further, in the description above, an example was shown in which the acoustic signal Y_n representing voice with a volume in accordance with the number of characters of the character string X_n is described. However, the condition of the character string X_n reflected by the volume of the acoustic signal Y_n is not limited to the number of characters. For example, a configuration can be employed in which the volume of the acoustic signal Y_n is set to a large value when the character string X_n is a specific word or phrase. In other words, any configuration can be used as long as the volume of the acoustic signal Y_n (one example of an acoustic characteristic) changes in accordance with the character string X_n.

### D: Fourth Embodiment

For example, at the end of the music event, cheers such as “encore,” are repeatedly generated at a prescribed cycle. In consideration of such circumstances, it is assumed that the user U_n of each terminal device 10_n repeatedly specifies the character string X_n such as “encore” in a prescribed cycle. The fourth embodiment is used when sound corresponding to a character string X_n that is repeatedly specified, as described above, is to be reproduced in the facility 200.

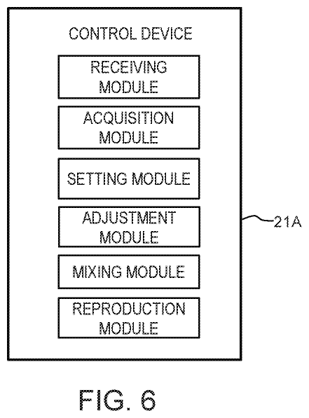

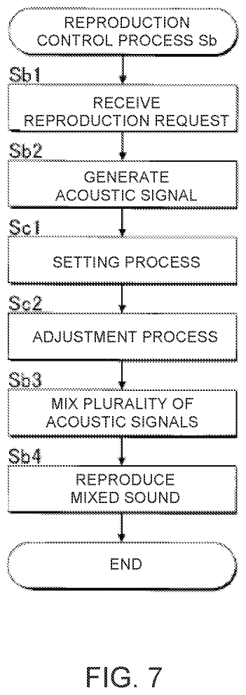

FIG. 6 is a block diagram illustrating the configuration of a control device in a fourth embodiment. FIG. 7 is a flowchart illustrating the specific procedure of the reproduction control process Sb in the fourth embodiment. In the fourth embodiment, the control device 21A further realizes functions as a setting module and an adjustment module, in addition to the receiving module, the acquisition module, the mixing module, and the reproduction module). In the reproduction control process Sb, when the acoustic signal Y_n in accordance with each reproduction request R_n is generated (process Sb2), the control device 21A of the control system 20 functions as an element (setting module) and executes a setting process Sc1, and functions as an element (adjustment module) and executes an adjustment process Sc2.

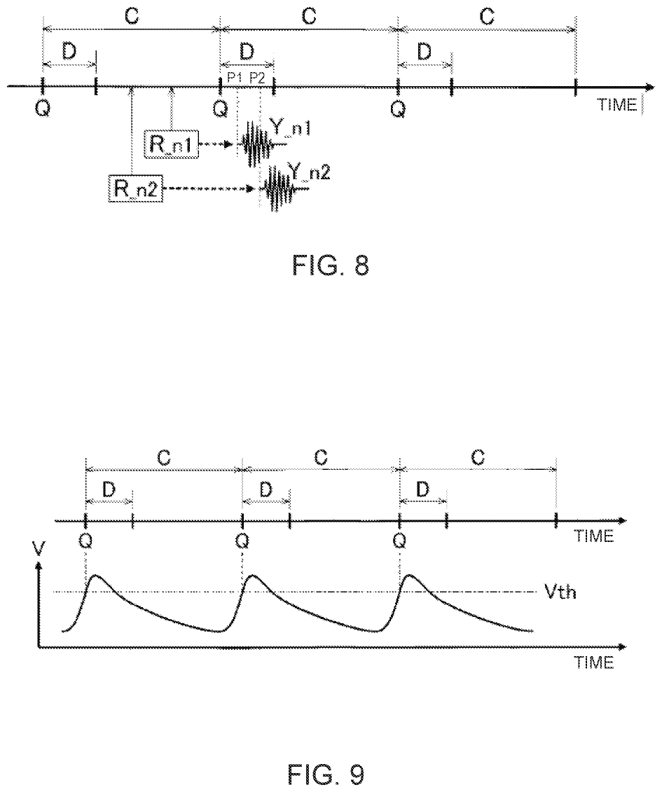

FIG. 8 is an explanatory diagram of the setting process Sc1 and the adjustment process Sc2. The setting process Sc1 is used to set a reference time point Q on a time axis. The control device 21A sets a plurality of reference time points Q on a time axis at prescribed intervals, for example. The beats of the musical piece performed by the performer P can be set as the reference time points Q.

Further, in the setting process Sc1, the control device 21A sets a specific period D for each reference time point Q. The specific period D corresponding to each reference time point Q is a period of prescribed length that includes said reference time point Q. Specifically, a period starting from the reference time point Q can be used as an example of the specific period D. However, a period having the reference time point Q as the midpoint or the ending point can be set as the specific period D.

The adjustment process Sc2 is a process for adjusting the positions of the plurality of the acoustic signals Y_n on the time axis. In the adjustment process Sc2, the control device 21A adjusts the starting points of the plurality of the acoustic signals Y_n within the specific period D. Specifically, the control device 21A adjusts each starting point of the plurality of the acoustic signals Y_n, respectively corresponding to the plurality of reproduction requests R_n received during a prescribed period (hereinafter referred to as “unit period”) C on the time axis, within the specific period D immediately after said unit period C. The unit period C is the period between the starting points of two consecutive specific periods D. For example, as illustrated in FIG. 8, when the reproduction request R_n1 and the reproduction request R_n2 are received within one unit period C, the control device 21A adjusts the starting point (first starting point P1) of the acoustic signal Y_n1 corresponding to the reproduction request R_n1 and the starting point (second starting point P2) of the acoustic signal Y_n2 corresponding to the reproduction request R_n2 within the specific period D immediately after said unit period C.

Further, in the adjustment process Sc2, the control device 21A distributes the starting points of the plurality of the acoustic signals Y_n within the specific period D. That is, the control device 21A distributes the starting points of each of the acoustic signals Y_n such that the starting points of the plurality of the acoustic signals Y_n do not coincide at one time point in the specific period D. For example, as illustrated in FIG. 8, the starting point of the acoustic signal Y_n1 and the starting point of the acoustic signal Y_n2 are distributed within the specific period D.

Specifically, each of the starting points of the plurality of the acoustic signals Y_n is distributed within the specific period D such that the number of starting points of the acoustic signals Y_n follows a frequency distribution, in which the frequency is maximum at the reference time point Q in the specific period D and decreases toward the ending point of the specific period D. That is, the starting points of the plurality of the acoustic signals Y_n are distributed appropriately within the specific period D, while being concentrated at the reference time point Q.

The control device 21A mixes a plurality of the acoustic signals Y_n after adjustment by the adjustment process Sc2 illustrated above, in order to generate the acoustic signal Z. The control device 21A causes the reproduction system 40 to reproduce the sound represented by the acoustic signal Z, in the same manner as in the first embodiment (process Sb4). As can be understood from the foregoing explanation, the reproduction of voices corresponding to the character strings X_n specified by different users U_n are reproduced, concentrated within the specific period D. Since the process described above is sequentially executed for each of the plurality of specific periods D, a situation in which the sounds corresponding to the plurality of character strings X_n are uttered at a specific cycle is reproduced within the facility 200.

The same effects that are realized in the first embodiment are realized in the fourth embodiment. Further, in the fourth embodiment, since the starting points of the plurality of the acoustic signals Y_n are aggregated within the specific period D on the time axis, it is possible to reproduce, by the reproduction system 40, a situation in which a plurality of sounds corresponding to the instructions from different users U_n are generated simultaneously.

If the starting points of the plurality of the acoustic signals Y_n coincide within the specific period D, it can be difficult for the performer P to ascertain the total number of the users U_n. In the fourth embodiment, since the starting points of the plurality of the acoustic signals Y_n are distributed within the specific period D, there is also the advantage that the performer P can readily ascertain the total number of the users U_n, compared with a case in which the starting points of the plurality of the acoustic signals Y_n coincide.

### E: Fifth Embodiment

In the first to the fourth embodiments, a case in which an audience is not present within the facility 200 was assumed. In the fifth embodiment, a case in which an audience is present in the facility 200 will be assumed. The recording device of the recording system 30 collects sounds generated during an actual performance of the performer P (for example, singing sounds or musical instrument sounds), and sounds generated by the audience in the facility 200 (for example, cheering or clapping sounds).

FIG. 9 is an explanatory diagram of the setting process Sc1 in the fifth embodiment. In the setting process Sc1, the control device 21 of the control system 20 identifies the volume V of the sounds present in the facility 200. Specifically, the control device 21 analyzes the sounds collected by the sound collection device of the recording system 30 in order to calculate the volume V.

In the setting process Sc1, the control device 21 sets the specific period D in accordance with the volume V. Specifically, the control device 21 sets the time point at which the volume V exceeds a prescribed threshold value Vth as the reference time point Q, and sets the specific period D that includes said reference time point Q. For example, assuming a scenario in which the audience in the facility 200 clap along with the actual performance of the performer P, the beat point of the hand clapping is set as the reference time point Q. In a situation in which members of the audience periodically clap their hands, a plurality of the reference time points Q are periodically set on the time axis. The contents of the adjustment process Sc2 using the specific period D and the reference time point Q set by the setting process Sc1 is the same as that of the fourth embodiment.

The same effects as those of the first embodiment and the fourth embodiment are also achieved in the fifth embodiment. Further, in the fifth embodiment, since the specific period D is set in accordance with the volume V in the facility 200, it is possible to link the reproduction of sounds by the reproduction system 40 with the changes in the volume V in the facility 200 (such as with the excitement of the audience in the facility 200). That is, the cheering of the audience in the facility 200 and the sounds corresponding to the instructions of the users U_n outside of the facility 200 can be generated together in the facility 200.

### F: Modified Examples

Specific modified embodiments to be added to each of the aforementioned embodiment's examples are illustrated below. A plurality of embodiments selected at random from the following examples can be appropriately combined as long as they are not mutually contradictory.

(1) In the embodiments described above, the pitch, volume, and voice quality (sound quality) of the voice represented by the acoustic signals Y_n are varied. However, the acoustic characteristics that arc varied for each of the acoustic signals Y_n are not limited to the example described above. For example, the acoustic characteristics can be frequency characteristics, reverberation characteristics (for example, reverberation time), a temporal change of pitch (pitch bend), a sound image localization position, a duration of sound (sound duration), and the like. An arbitrary acoustic characteristic can be set for each of the acoustic signals Y_n. Two or more types of acoustic characteristics can be made to differ for each of the acoustic signals Y_n.

In the second embodiment, the voice quality of the acoustic signal Y_n is controlled in accordance with the attribute of the user U_n, but the acoustic characteristics other than voice quality relating to the acoustic signal Y_n can be controlled in accordance with the attributes of the user U_n. Further, in the third embodiment, the volume of the acoustic signal Y_n is controlled in accordance with the character string X_n, but an acoustic characteristic other than the volume relating to the acoustic signal Y_n can be controlled in accordance with the character string X_n.

(2) In each of the embodiments described above, the acoustic signal Y_n corresponding to the character string X_n is generated by a speech synthesis process, but the method of acquiring the acoustic signal Y_n is not limited to the example described above. For example, the acoustic signal Y_n recorded or synthesized in advance can be read from the storage device 22. For example, for each of a plurality of character strings that are assumed to be specified by the user U_n, an acoustic signal representing voice corresponding to each character string is stored in the storage device 22. The control device 21 reads from the storage device 22, from among the plurality of acoustic signals stored in the storage device 22, the acoustic signal corresponding to the character string X_n corresponding to the instruction by the user U_n as the acoustic signal Y_n. As can be understood from the foregoing explanation, the process for acquiring the acoustic signal Y_n includes, in addition to the process for generating the acoustic signal Y_n by speech synthesis process, a process for reading the acoustic signal Y_n recorded or synthesized in advance from the storage device 22.

The process for generating the acoustic signal Y_n by speech synthesis process and the process for reading out the acoustic signal Y_n prepared in advance can be used in combination. For example, if the acoustic signal Y_n corresponding to the character string X_n is stored in the storage device 22, the control device 21 reads the acoustic signal Y_n from the storage device 22. On the other hand, if the acoustic signal Y_n corresponding to the character string X_n is not stored in the storage device 22, the control device 21 generates the acoustic signal Y_n by a speech synthesis process applied to said character string X_n.

(3) In each of the embodiments described above, the reproduction of the video represented by the video data M and the acceptance of instructions from the users U_n are executed by the terminal device 10_n; however, the embodiments are not limited to such examples. A reproduction device that is separate from the terminal device 10_n that accepts instructions from the users U_n can be made to reproduce the video of the video data M. The reproduction device that reproduces the video can be an information terminal such as a smartphone or a tablet device, or video equipment such as a television receiver.

(4) In each of the embodiments described above, the user U_n specified the character string X_n, but an inputting of the character string X_n by the user U_n is not essential. For example, the user U_n can select one of a plurality of options corresponding to different character strings using the operation device 15. The terminal device 10_n transmits the reproduction request R_n, which includes identification information of the option selected by the user U_n, to the control system 20. From the plurality of acoustic signals stored in the storage device 22 with respect to different pieces of identification information, the control device 21 of the control system 20 reads the acoustic signal that corresponds to the identification information in the reproduction request R_n, as the acoustic signal Y_n, from the storage device 22. The same effect as in the first embodiment is realized by the configuration described above by making the acoustic characteristic of each acoustic signal Y_n different.

(5) In each of the embodiments described above, a configuration in which the acoustic signal Y_n represents voice (speech) is used as an example, but the sound represented by the acoustic signal Y_n is not limited to voice. For example, the acoustic signal Y_n representing various acoustic effects can be acquired by the control device 21. Specific examples of the acoustic effects represented by the acoustic signal Y_n can include the sounds generated by clapping or whistling, or the sounds of music produced by the playing of a musical instrument, such as a drum.

(6) The greater the communication delay in the communication of the reproduction request R_n, the more remote the user U_n tends to be located. In consideration of this tendency, the positions of the starting points of the acoustic signals Y_n in the specific period D can be distributed in accordance with the communication delay. For example, the starting points of the acoustic signals Y_n can be adjusted within the specific period D such that the time difference with respect to the reference time point Q increases as the communication delay increases. By such a configuration, the starting points of the acoustic signals Y_n are close to each other for users U_n whose distances from the control system 20 are similar.

(7) Generally, each of the users U_n is assumed to input the character string X_n within the interval between successive musical performances. However, due communication delays, etc., there are cases in which the reproduction request R_n including the character string X_n specified by the user U_n during the interval between musical performances arrives at the control system 20 immediately after the start of the musical piece that immediately follows. Assuming the circumstance described above, for example, a configuration in which reproduction of sound by the reproduction system 40 is stopped during the performance of a musical piece at a music event also can be assumed.

For example, the control device 21 of the control system 20 analyzes sounds collected by the sound collection device of the recording system 30 in order to determine whether a musical piece is being performed in the facility 200. A manager of the music event can indicate to the control system 20 whether a musical piece is being performed. If it is determined that a musical piece is not being played, the control device 21 supplies the acoustic signal Z to the reproduction system 40 in order to reproduce sounds within the facility 200, in the same manner as the embodiments described above. On the other hand, if it is determined that a musical piece is being performed, the control device 21 stops supplying the acoustic signal Z to the reproduction system 40. Generation (process Sb2) and mixing (process Sb3) of the acoustic signal Y_n can be stopped during the performance of the musical piece. If the musical piece is being performed, the acoustic signal Z can be supplied to the reproduction system 40 after the volume of the acoustic signal Z has been reduced in comparison to when the musical piece is not being performed.

(8) In each of the embodiments described above, a music event is used as an example, but the scenarios to which the aforementioned embodiments are applied are not limited to music events. The aforementioned embodiments can be applied to various events carried out for specific purposes, such as competitive events in which a plurality of athletes (teams) compete in sports, theater events in which actors appear, dance events in which dancers perform, lecture events in which speakers give lectures, and educational events in which various educational institutions such as schools and preparatory schools provide classes to students.

(9) As described above, the functions of the control system 20 used as an example above are realized by cooperation between one or a plurality of processors that constitute the control device 21 and a program stored in the storage device 22. The program can be provided in a form stored in a storage medium that can be read by a computer and installed in the computer. The storage medium is, for example, a non-transitory storage medium, a good example of which is an optical storage medium (optical disc) such as a CD-ROM, but can include storage media of any known form, such as a semiconductor storage medium or a magnetic storage medium. Non-transitory storage media include any storage medium that excludes transitory propagating signals and does not exclude volatile storage media. Further, in a configuration in which a distribution device distributes the program via a communication network, a storage medium that stores the program in the distribution device corresponds to the non-transitory storage medium.

### G: Additional Statement

From the foregoing embodiment examples, the following configurations, for example, are understood.

A reproduction control method according to one aspect (Aspect 1) of the present disclosure comprises receiving, from a first terminal device, a first reproduction request in accordance with an instruction from a first user; receiving, from a second terminal device, a second reproduction request in accordance with an instruction by a second user; acquiring a first acoustic signal representing a sound in accordance with the first reproduction request, and a second acoustic signal representing a sound having acoustic characteristics that differ from the sound represented by the first acoustic signal and that is in accordance with the second reproduction request; mixing the first acoustic signal and the second acoustic signal to generate a third acoustic signal; and causing a reproduction system to reproduce the sound represented by the third acoustic signal. In the configuration described above, a mixed sound of sound in accordance with an instruction from the first user and sound in accordance with an instruction from the second user is reproduced from the reproduction system. Since the acoustic characteristics of the sound represented by the first acoustic signal and the sound represented by the second acoustic signal are different from each other, there is the advantage that a listener (for example, performers at various events) of the sound reproduced by the reproduction system can easily ascertain the situation of the users (such as their total number or their reactions).

In a specific example (Aspect 2) of Aspect 1, the acoustic characteristics include one or more of the following: pitch, volume, sound quality, frequency characteristics, reverberation characteristics, temporal change of pitch, sound image localization position, and sound duration.

In a specific example (Aspect 3) of Aspect 1 or 2, the first reproduction request includes a first character string specified by the first user, the second reproduction request includes a second character string specified by the second user, in the acquisition, the first acoustic signal representing voice corresponding to the first character string is generated by speech synthesis process applied to the first character string, and the second acoustic signal representing voice corresponding to the second character string is generated by speech synthesis process applied to the second character string. By the aspect described above, various acoustic signals corresponding to any character string specified by each user can be generated.

In a specific example (Aspect 4) of Aspect 3, in the speech synthesis process, the first acoustic signal representing an acoustic characteristic corresponding to an attribute of the first user is generated, and the second acoustic signal representing an acoustic characteristic corresponding to an attribute of the second user is generated. By the aspect described above, acoustic signals having various acoustic characteristics corresponding to user attributes can be generated.

In a specific example (Aspect 5) of Aspect 3 or 4, in the speech synthesis process, the first acoustic signal representing an acoustic characteristic corresponding to the first character string is generated, and the second acoustic signal representing an acoustic characteristic corresponding to the second character string is generated. By the aspect described above, acoustic signals having various acoustic characteristics corresponding to the character string specified by the user can be generated.

In a specific example (Aspect 6) of any one of Aspects 1 to 5, in the mixing, a starting point of the first acoustic signal and a starting point of the second acoustic signal are adjusted within a specific period on a time axis, and the first acoustic signal whose starting point has been adjusted and the second acoustic signal whose starting point has been adjusted are mixed. By the aspect described above, the starting points of the first acoustic signal and the second acoustic signal are concentrated within the specific period on the time axis. Therefore, the reproduction system can reproduce a situation in which a plurality of sounds are generated simultaneously.

In a specific example (Aspect 7) of Aspect 6, in the adjustment, the starting point of the first acoustic signal and the starting point of the second acoustic signal are distributed within a specific period. By the aspect described above, since the starting point of the first acoustic signal and the starting point of the second acoustic signal are distributed within the specific period, it is possible to reproduce sounds with which the performer can readily ascertain the total number (scale) of the users compared to a case in which the starting points of the first acoustic signal and the second acoustic signal coincide on the time axis.

In a specific example (Aspect 8) of Aspect 6 or 7, the specific period is set in accordance with the volume of sounds collected in an acoustic space in which the reproduction system is installed. By the aspect described above, since the specific period is set in accordance with the volume in the acoustic space, it is possible to link the reproduction of mixed sounds by the reproduction system with the changes in the volume in the acoustic space (such as with the excitement of the audience in the acoustic space).

The present disclosure is implemented as a control system that can realize the reproduction control method according to each aspect (Aspects 1 to 8) described above, and a program that causes a computer system to execute the reproduction control method.

What is claimed is:

1. A reproduction control method implemented by a computer, the reproduction control method comprising:
receiving, from a first terminal device, a first reproduction request in accordance with an instruction from a first user;
receiving, from a second terminal device, a second reproduction request in accordance with an instruction from a second user;
acquiring a first acoustic signal representing a first sound in accordance with the first reproduction request, and a second acoustic signal representing a second sound in accordance with the second reproduction request, the second sound having acoustic characteristics that differ from acoustic characteristics of the first sound represented by the first acoustic signal;
mixing the first acoustic signal and the second acoustic signal, thereby generating a third acoustic signal; and
causing a reproduction system to reproduce a third sound represented by the third acoustic signal.

2. The reproduction control method according to claim 1, wherein
the acoustic characteristics of the first and second sounds include one or more of a pitch, a volume, a sound quality, frequency characteristics, reverberation characteristics, a temporal change of pitch, a sound image localization position, and a sound duration.

3. The reproduction control method according to claim 1, wherein
the first reproduction request includes a first character string specified by the first user,
the second reproduction request includes a second character string specified by the second user, and
the acquiring is performed by
generating the first acoustic signal that represents voice corresponding to the first character string by applying the first character string to a speech synthesis process, and
generating the second acoustic signal that represents voice corresponding to the second character string by applying the second character string to the speech synthesis process.

4. The reproduction control method according to claim 3, wherein
in the speech synthesis process,
the first acoustic signal representing first acoustic characteristics in accordance with an attribute of the first user is generated, and
the second acoustic signal representing second acoustic characteristics in accordance with an attribute of the second user is generated.

5. The reproduction control method according to claim 3, wherein
in the speech synthesis process,
the first acoustic signal representing first acoustic characteristics in accordance with the first character string is generated, and
the second acoustic signal representing second acoustic characteristics in accordance with the second character string is generated.

6. The reproduction control method according to claim 1, further comprising
adjusting a first starting point of the first acoustic signal and a second starting point of the second acoustic signal within a specific period on a time axis, wherein
in the mixing, the first acoustic signal for which the first starting point has been adjusted and the second acoustic signal for which the second starting point has been adjusted are mixed.

7. The reproduction control method according to claim 6, wherein
the adjusting is performed such that the first starting point and the second starting point are distributed within the specific period.

8. The reproduction control method according to claim 6, further comprising
setting the specific period in accordance with a volume of sounds collected in an acoustic space in which the reproduction system is installed.

9. A control system comprising:
an electronic controller including at least one processor, the electronic controller being configured to execute a plurality of modules including
a receiving module configured to receive, from a first terminal device, a first reproduction request in accordance with an instruction from a first user, and receive, from a second terminal device, a second reproduction request in accordance with an instruction from a second user,
an acquisition module configured to acquire a first acoustic signal representing a first sound in accordance with the first reproduction request, and a second acoustic signal representing a second sound in accordance with the second reproduction request, the second sound having acoustic characteristics that differ from acoustic characteristics of the first sound represented by the first acoustic signal,
a mixing module configured to mix the first acoustic signal and the second acoustic signal, thereby generating a third acoustic signal, and
a reproduction module configured to cause a reproduction system to reproduce a third sound represented by the third acoustic signal.

10. The control system according to claim 9, wherein
the acoustic characteristics of the first and second sounds include one or more of a pitch, a volume, a sound quality, frequency characteristics, reverberation characteristics, a temporal change of pitch, a sound image localization position, and a sound duration.

11. The control system according to claim 9, wherein
the first reproduction request includes a first character string specified by the first user,
the second reproduction request includes a second character string specified by the second user, and
the acquisition module is configured to generate the first acoustic signal that represents voice corresponding to the first character string by applying the first character string to a speech synthesis process, and generate the second acoustic signal that represents voice corresponding to the second character string by applying the second character string to the speech synthesis process, to acquire the first acoustic signal and the second acoustic signal.

12. The control system according to claim 11, wherein
in the speech synthesis process,
the acquisition module is configured to generate the first acoustic signal representing first acoustic characteristics in accordance with an attribute of the first user, and
the acquisition module is configured to generate the second acoustic signal representing second acoustic characteristics in accordance with an attribute of the second user.

13. The control system according to claim 11, wherein
in the speech synthesis process,
the acquisition module is configured to generate the first acoustic signal representing first acoustic characteristics in accordance with the first character string, and
the acquisition module is configured to generate the second acoustic signal representing second acoustic characteristics in accordance with the second character string.

14. The control system according to claim 1, wherein
the electronic controller is further configured to execute an adjustment module configured to adjust a first starting point of the first acoustic signal and a second starting point of the second acoustic signal within a specific period on a time axis, and
the mixing module is configured to mix the first acoustic signal for which the first starting point has been adjusted and the second acoustic signal for which the second starting point has been adjusted.

15. The control system according to claim 14, wherein
the adjustment module is configured to adjust the first starting point and the second starting point such that the first starting point and the second starting point are distributed within the specific period.

16. The control system according to claim 14, wherein
the electronic controller is further configured to execute a setting module configured to set the specific period in accordance with a volume of sounds collected in an acoustic space in which the reproduction system is installed.

17. A non-transitory computer-readable medium storing a program that causes a computer to function as
a receiving module configured to receive, from a first terminal device, a first reproduction request in accordance with an instruction from a first user, and receive, from a second terminal device, a second reproduction request in accordance with an instruction from a second user;
an acquisition module configured to acquire a first acoustic signal representing a first sound in accordance with the first reproduction request, and a second acoustic signal representing a second sound in accordance with the second reproduction request, the second sound having acoustic characteristics that differ from acoustic characteristics of the first sound represented by the first acoustic signal;
a mixing module configured to mix the first acoustic signal and the second acoustic signal, thereby generating a third acoustic signal; and
a reproduction module configured to cause a reproduction system to reproduce a third sound represented by the third acoustic signal.
